(19) United States
(12) Patent Application Publication
(10) Pub. No.: US 2015/0283495 A1
(43) Pub. Date: Oct. 8, 2015

(54) APPARATUS FOR PREVENTING MICROPARTICLE AND DUST MIGRATION IN LAYERED BED PURIFICATION DEVICES

(71) Applicants: DOW GLOBAL TECHNOLOGIES LLC, Midland, MI (US); ROHM AND HAAS CHEMICALS LLC, Philadelphia, PA (US)

(72) Inventors: Peter K. Shogren, Chula Vista, CA (US); Daimhin P. Murphy, San Diego, CA (US); Abneesh Srivastava, Amherst, NY (US); Stenio da Costa Pereira, San Diego, CA (US)

(73) Assignee: Entegris, Inc., Billerica, MA (US)

(21) Appl. No.: 14/426,497

(22) PCT Filed: Aug. 28, 2013
(86) PCT No.: PCT/US2013/057025

§ 371 Date: Mar. 6, 2015

Related U.S. Application Data
(60) Provisional application No. 61/762,313, filed on Feb. 8, 2013.
(60) Provisional application No. 61/698,845, filed on Sep. 10, 2012.

(51) Int. Cl. B01D 53/04; B01J 8/04; B01J 8/02

(52) U.S. Cl. CPC B01D 53/0407; B01J 8/02; B01J 8/04; B01D 2253/116; B01D 2253/102; B01D 2253/204; B01D 2259/45; B01J 2208/027; B01J 2208/00884

(57) ABSTRACT

The invention relates to an expandable media-retaining ring comprising an expandable ring and a gas permeable media-retaining membrane. The invention further relates to a gas purifier device comprising two or more beds of purification media and an expandable media-retaining ring. The expandable media-retaining ring is secured by radial force in the device, and prevents migration of purification media into adjacent beds, thereby improving the performance of the purifier device, and also enabling the device to be used in any orientation.

### RELATED APPLICATIONS

This application claims the benefit of U.S. Provisional Application No. 61/698,845, filed on Sep. 10, 2012 and U.S. Provisional Application No. 61/762,313, filed on Feb. 8, 2013. The entire teachings of the above applications are incorporated herein by reference.

### BACKGROUND OF THE INVENTION

U.S. Pat. No. 4,135,896, Parish et al., issued Jan. 23, 1979, discloses a sample purifier canister or containment means that includes a channeling means structure having generally a curved, right angle disposition with the containment means. The containment means includes sample adsorbent being oriented vertically, either substantially straight up or straight down by the channeling means. This upright orientation is to eliminate undesirable channeling effects through the adsorbent which may occur if the containment means is not disposed vertically. Undesirable channeling effects can occur in the canister if adsorbent in the containment means portion of the sample canister settles to one side and a void can be formed which is a passageway through which gas could flow without substantially contacting adsorbent. If the containment means is always oriented vertically, undesirable channeling cannot occur and all gas passing through the containment means will pass through the adsorbent therein. Although the canister includes mesh means and a retaining ring between portions of adsorbent in the canister, the adsorbent is not restrained by the mesh or ring. Multiple separate layers of purification media that each remove a specific contaminant are not disclosed. It is costly and adds manufacturing steps to make grooves in the housing wall that accept the ring.

U.S. Pat. No. 7,918,923 Applegarth, et al., issued Apr. 5, 2011, discloses gas purification with carbon based materials. The first, second, and third different carbon based media are respectively located within the first, second, and third zones that are physically separated by the partitions which include a particle filter, a metallic mesh, or some other physical structure effective to retain the first, second, and third media within their respective zones without blocking the passage of gas through the zones. There is no disclosure on how the particle filter or metallic mesh is held in place within the housing to prevent media fines and particles from migrating from one zone to another nor is there an appreciation for how even small amounts of media migration from one zone to another can affect purifier stability and removal performance.

U.S. Pat. No. 5,769,928, Leavitt, et al., issued Jun. 23, 1998 discloses a PSA gas purifier and purification process. The disclosure includes a PSA prepurifier adsorbent bed where the lower header is filled with inert ceramic balls which act as both flow distribution and bed support. A stainless steel screen supports the adsorbent bed. The bed itself consists of two layers. The lower and larger layer is activated alumina; the smaller upper layer is NaY. The upper bed surface is constrained by a second stainless steel screen which is held in place by an additional layer of ceramic balls which fill the upper header. The ceramic balls in the header spaces may be graded to provide improved distribution. The use of ceramic balls to hold the stainless steel screen supports adds cost and increases the size of the prepurifier; the position of the screen at the inlet and outlet of the prepurifier would not prevent migration of particles or fines of the upper layer into the lower layer.

There remains a need to develop a purifier that comprises multiple separate beds of purification media, each useful for removing a different set of contaminants, that also comprises a mechanism for preventing migration of particles of one type of purification media into a bed of another type of purification media. Such migration of purification media contributes to decreased efficiency of purifier performance.

### SUMMARY OF THE INVENTION

One version of the invention is a gas purifier comprising at least an upstream purification media and a downstream purification media in a housing having a fluidly connected fluid inlet and a fluid outlet, the upstream and downstream purification media capable of removing different impurities or amounts of impurities from a gas stream. The upstream and downstream purification media are separated by a gas-permeable membrane that is in an intimate and retaining contact relationship with the downstream media layer. The gas permeable membrane is a porous media-retaining membrane that is secured within the housing at its edges by an expandable ring comprising both an inner and outer circumference, and further comprising a locking mechanism for expanding and retaining the ring by radial force in the housing of a filtration device. The contact of the gas-permeable membrane with the downstream media holds the downstream media in place in the housing and the contact allows the purifier to be used in any orientation without channeling occurring in downstream media during use of the purifier. The secured gas-permeable membrane prevents gas flow around the edges of the gas-permeable membrane in the housing and directs gas flow and any upstream media particles or microparticles therein to flow through the gas-permeable membrane where upstream media particles and upstream media microparticles are retained. In versions of the invention, the gas-permeable membrane has a pore size that prevents particles of purification media from passing therethrough.

In versions of the invention the porous membrane has a surface that is in complete contact with the downstream purification media and the porous membrane is fixed in the purifier housing such that the contact of the porous membrane with the downstream media firmly holds the media in place in the housing. This feature in which the porous membrane is fixed at its edges and in firm contact with the downstream media in the housing allows the purifier to be used in any orientation without channeling through the downstream media occurring during use of the purifier. This purifier structure also provides improved gas purifier impurity removal capability and improved gas purity concentration stability as compared to a purifier with a porous membrane between media layers that is not fixed at its edges.

The gas purifier devices described herein are useful for the efficient removal of multiple impurities from fluids and possess novel features over known purification devices that contribute to their improved performance. The devices comprise multiple beds of purification media separated by a gas permeable membrane that retains the particles of purification media in their respective beds. The beds of purification media are compositionally the same, alternately compositionally different. The beds purification media each independently comprise a metal catalyst on high surface area support media, dessicant material, molecular sieves, zeolites, an organometallic reagent on support media, getter material, or carbon-based media. The gas permeable membrane that retains the particles of purification media in their respective beds is, in some versions of the invention, metallic, semi-metallic, carbon based, ceramic, polymeric, or thermally conductive, and, in some versions of the invention, is in the form of a felt, a wire mesh, sintered particles, electro-blown fibers, woven membrane, or non-woven membrane. The invention described herein provides that the pore size of the media retaining membrane is from about 0.05 microns to about 1.0 microns.

The membrane is coupled with a retaining ring that firmly secures the membrane in the housing of the device, keeping the membrane in intimate and retaining contact with the downstream purification media. The coupling of the membrane and the retaining ring forcing any gas that flows into the purifier through the membrane, and further enables the device to be used in any orientation. Importantly, the retaining ring is secured in the housing by radial force, preventing the need for machining a housing with grooves in the interior wall. This feature would enable use of the retaining ring and membrane in existing gas purifier devices.

The invention also provides for an expandable media-retaining ring comprising an expandable ring and a media-retaining porous membrane. The expandable ring comprises both an inner and outer circumference, and further comprises a locking mechanism, which enables the expandable ring to expand and be retained by radial force when inserted into the housing of a filtration device. One advantage of feature that the ring is retained by radial force is that no additional tooling or machining is necessary to create a groove along the inner wall of the housing. The media-retaining porous membrane of the expandable media-retaining ring comprises a gas-permeable material of a pore size to prevent particles of media from passing through. In some versions of the expandable media-retaining ring, the media-retaining porous membrane is affixed to the expandable ring. In some versions of the invention, the expandable ring comprises metal (e.g. stainless steel), plastic, or metal alloy, and has a thickness of from about 0.06 inches to about 0.12 inches. The locking mechanism of the expandable ring is a spring-locking mechanism in certain versions of the invention. The invention describes that the gas-permeable material is metallic, semi-metallic, carbon based, ceramic, polymeric, or thermally conductive, and is in the form of a felt, a wire mesh, sintered particles, electro-blown fibers, woven membrane, or non-woven membrane. The invention described herein provides that the pore size of the media retaining membrane is from about 0.05 microns to about 1.0 microns.

While several exemplary articles, compositions, apparatus, and methods embodying aspects of the present invention have been shown, it will be understood, of course, that the invention is not limited to these versions. Modification may be made by those skilled in the art, particularly in light of the foregoing teachings. For example, components and features of one version may be substituted for corresponding components and features of another version. Further, the invention may include various aspects of these versions in any combination or sub-combination.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows the moisture concentration in parts per billion by volume in hydrogen gas after treatment with a purification device as a function of time in hours.

FIG. 2 shows a series of images of a gas purifier, used with or without an expandable media-retaining ring, or snap ring, to fix and retain the membrane. The top image is from a used gas purifier without a snap ring, and shows a downstream media layer with deposits of particles from the upstream media layer. The center image shows the gas purifier with an expandable media-retaining ring and membrane retained in the housing. The bottom image is from a used gas purifier equipped with an expandable ring, and shows a downstream media layer that does not exhibit any deposits of particles from the upstream layer.

FIG. 3 illustrates a non-limiting version of the purifier invention that includes a housing with gas inlet (top) and gas outlet (bottom), an upstream fit near the inlet, an upstream purification media separated from a downstream purification media by a membrane that is held securely in contact with a top surface of the downstream media, the downstream media overlies a particle filter or fit near the outlet of the housing. The top media layer (fine dots) is shown being separated from a bottom media layer (coarse dots) by a membrane or separator and a ring. Alternately, the membrane could be secured by being brazed at its edges to the housing and the ring eliminated.

### DETAILED DESCRIPTION OF THE INVENTION

While this invention has been particularly shown and described with references to example embodiments thereof, it will be understood by those skilled in the art that various changes in form and details may be made therein without departing from the scope of the invention encompassed by the appended claims.

While various compositions and methods are described, it is to be understood that this invention is not limited to the particular molecules, compositions, designs, methodologies or protocols described, as these may vary. It is also to be understood that the terminology used in the description is for the purpose of describing the particular versions or versions only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “media particle” is a reference to one or more media particles and equivalents thereof known to those skilled in the art, and so forth. Unless defined otherwise, all technical and scientific terms used herein have the same meanings as commonly understood by one of ordinary skill in the art. Methods and materials similar or equivalent to those described herein can be used in the practice or testing of versions of the present invention. All publications mentioned herein are incorporated by reference in their entirety. Nothing herein is to be construed as an admission that the invention is not entitled to antedate such disclosure by virtue of prior invention. “Optional” or “optionally” means that the subsequently described event or circumstance may or may not occur, and that the description includes instances where the event occurs and instances where it does not. All numeric values herein can be modified by the term “about,” whether or not explicitly indicated. The term “about” generally refers to a range of numbers that one of skill in the art would consider equivalent to the recited value (i.e., having the same function or result). In some versions the term “about” refers to ±10% of the stated value, in other versions the term “about” refers to ±2% of the stated value. While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

One problem with purifiers that include multiple separate beds of materials or multiple separate layers of purification media, each layer removing a specific contaminant, is that there can be migration of material from one bed into an adjacent bed. Even when a partition, filter, or mesh screen is used, they can tilt during use or have passages at their edges that allow bed or particle migration from one layer to another. The migration of material from one layer to another results in decreased purifier performance because the downstream purifier media may become partially coated with upstream purifier media and therefore have less contaminant removal capacity or stability.

This problem can be solved by using a purifier that includes at least an upstream purification media and a different downstream purification media, a gas permeable membrane that retains media particles and media fines or dust, that is between the upstream and the downstream media. The membrane firmly holds or retains the downstream media in place in the purifier housing with sufficient force to prevent channeling of the downstream media regardless of purifier housing orientation. The membrane is secured uniformly at its edges so that any gas with upstream media particles is forced to flow through the membrane where these media particles are retained.

Versions of the invention include a gas purifier with a first upstream purification media and at least a second downstream purification media, wherein the first and second purification media remove different impurities from a gas stream. In other versions of the invention, the first and second purification media beds remove particles of impurities, wherein the particles are of different sizes. The first and second purification media are separated by a porous membrane that is in an intimate and retaining contact relationship with the downstream media layer, the contact of the porous membrane with the media holds the downstream media in place in the housing and allows the purifier to be used in a horizontal orientation, a vertical orientation, or any orientation without channeling through the downstream media occurring during use of the purifier. For the porous membrane to retain the purification media, the edges of the membrane that are in contact with the downstream media are secured or fixed such that fines or particles of upstream media cannot migrate to the downstream media layer around the edges of the membrane. By fixing the edge portion of the membrane a high resistance to gas flow is created, as compared to when the edges of the membrane are not secured or fixed, which directs gas flow and any upstream media particles therein to flow through the membrane where media fines and media particles can be retained.

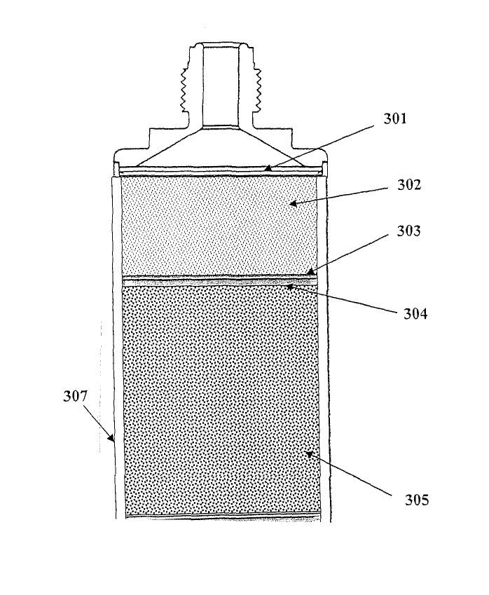

An illustration of a purifier housing is illustrated in FIG. 3. The purifier includes a housing 307 that can be fit with an inlet and an outlet. The purifier comprises an upstream fit 301 near the fluid inlet, a bed of upstream purification media 302, a bed of downstream purification media 305 and a downstream fit 306 near the fluid outlet. Further, membrane 304 separates purification beds 302 and 305 from each other, preventing fines or particles of media from migrating into the adjacent bed. Membrane 304 overlies the downstream media, and its edges are in contact with 305 and are secured in place by retaining ring 303, which is held in place in housing 307 by radial force. Notably the housing 307 does not include a groove in the side wall for an expandable media-retaining ring or snap ring to hold the membrane or other mesh. As shown in FIG. 3, the expandable ring 303 is an annular ring that provides a radial force against the housing and holds the porous membrane in place against the downstream purification media. Because the expandable ring is held in place in the housing by exerting radial force against the inner wall of the housing, this feature provides a great advantage in that no additional and costly tooling is necessary to create a groove along the inner wall of the housing. This further provides the advantage of the expandable media-retaining ring being usable in existing gas purifier devices.

The purifier has at least a first purification media and a second purification media with the two media removing different contaminants, or to different levels of purity, from a gas stream. Additional purification layers may also be present that remove different contaminants or to different levels of purity, from the gas stream than either the first purification media or the second purification media. Purifier media can include various metal catalysts on high surface area supports, dessicants, molecular sieves, and zeolites, various organo-metallic reagents on supports, getter materials, and carbon based media.

A porous membrane, which can also be referred to as a separator in versions of the invention is placed between one or more layers of the purification media. The membrane is porous and can be metallic, semi-metallic, carbon based or ceramic; it may also be a thermally conductive material or a polymeric material. A thermally conductive membrane can advantageously improve the thermal distribution in a purifier, which increases the amount of contaminants desorbed during activation, thereby increasing the lifetime of the purifier. The membrane can be in the form of a felt, a wire mesh, sintered particles, extruded, cast, or electro-blown polymeric material. In one version of the invention, the porous membrane is stainless steel felt.

The membrane or separator has two substantially opposing surfaces and an edge. An entire surface, or substantially the entire surface, of one face of the membrane contacts the top surface of one purification media layer. An outer region of the membrane is secured to the inside perimeter of the housing by friction or bonding. A membrane can be positioned between each media layer in the purifier; in some versions, a membrane is positioned between each media layer; in other versions, a membrane is positioned between layers where media migration can occur, but may be absent between other media layers.

The membrane is secured uniformly at its edges so that any gas with upstream media particles is forced to flow through the membrane; there are no gaps at the edges for particles to bypass the membrane, and any media particles, fines, or dust are retained by the membrane. In some versions of the invention, the membrane is secured through the use of an expandable media-retaining ring.

An expandable media-retaining ring means an expandable ring with a locking mechanism optionally affixed to a media-retaining gas-permeable membrane. In some versions of the invention, the expandable media-retaining ring includes a media-retaining gas-permeable membrane, and in other versions of the invention, the expandable media-retaining ring refers to just the expandable ring with locking mechanism. In some versions of the invention, the expandable media-retaining ring is alternately referred to as a snap ring, or a retaining ring herein.

One way to secure the membrane uniformly at its edges is by using an expandable media-retaining ring, alternatively a snap ring or retaining ring, overtop of the membrane which overlies the downstream media. In other versions, the separator or membrane could be welded or brazed to the inner housing surface. Alternatively, the separator or membrane may be press fit into the housing. Preferably, the edges of the membrane are secured or fixed, for example, by a snap ring that sandwiches the membrane between the downstream media and a bottom snap ring surface. In some embodiments, the membrane is secured or fixed into the housing by a brazed or welded seal between edges of the membrane and housing.

In one version of the invention, the membrane is secured by an expandable media-retaining ring, or snap ring, that has an inner diameter and an outer diameter and a locking mechanism to retain it within the housing. Preferably, the locking mechanism is a spring-locking mechanism. The retaining ring is placed in the housing with the locking mechanism disengaged so that the ring can be positioned in the housing. When the ring is positioned, it is pressed against and touches one surface of the membrane (the opposite surface of the membrane touches the top surface of the downstream purifier media), the locking mechanism is secured and contacts the outer diameter of the retaining ring against the inner housing wall. The retaining ring is secured against the inner wall of the housing by tension or radial force. In some versions of the invention, the retaining ring has a thickness of between 0.06 inches and 0.12 inches. This thickness range provides a ring with sufficient strength to withstand pressure changes during use of the purifier and regeneration of the purifier and maintains contact of the membrane with the downstream media. The retaining ring, taken together with the membrane, is not compressible, or at the very least, is minimally compressible. This is an important operational feature, because a compressible retaining ring and membrane would cause a disadvantageous increase in pressure drop.

In versions of the invention, the purification media for the layer, preferably the downstream layer, is tamped down, vibrated or otherwise compacted in a housing to reduce voids in the media layer. A membrane cut to a size of an inner cross sectional area of the housing, for example a size which allow the membrane to be brazed to the housing wall, a size that allows it to be press fit, or a size that allows the membrane to be secured in place by a retaining ring against the media, is placed on the housing and atop the media. The membrane is then secured within the housing. In some embodiments of the invention, the membrane is secured within the housing by a retaining ring, held in the housing by radial force.

The porous membrane has a pore size that retains particles from any purification media it is in contact with. The particles which are retained may be actual media beads or extrudates, fines and dust, or smaller particles (micron and submicron media particles). The membrane secured in the housing does not impede gas flow through the purifier housing and more than the purification media bed layer or internal filter of the purifier. Small or larger pore sized membrane could be chosen depending upon the media and its propensity to form dust and other fines (micron sized particles). In some versions of the invention, the pore size of the membrane can be 0.05 microns to 1 micron; in other versions of the invention, the pore size of the membrane can be 0.1 microns. In other versions of the invention, the pore size of the membrane can be less than 10 microns, preferably from about 2 to about 5 microns. In some versions of the invention, the porous membrane can be a microporous membrane. The pore size of the membrane can be determined by aerosol retention test or retention test using salt particles and the like.

Advantages of versions of the present invention include that there is no need for a groove in the housing which reduces costs and makes it possible to “pack” the membrane to conform to actual volume of purification media that is present in the housing which prevents channeling of the media and allows the purifier to be used in a vertical orientation, a horizontal orientation, or any other orientation. Securing the edges of the membrane prevents media migration and improves purifier performance It is unexpected that substantially reducing or eliminating gas flow at the edges of a membrane by fixing the edge of the membrane would lead to such an improvement in purifier impurity removal and stability.

Although the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature or aspect of the invention may have been disclosed with respect to only one of several implementations, such feature or aspect may be combined with one or more other features or aspects of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.” Also, the term “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated herein.

### EXAMPLES

Example 1. Purification of hydrogen gas in with and without retaining ring.

It was previously assumed that in multilayer purifiers there was minimal layer migration and that migration of microparticles (micron and submicron sized particles from about 0.03 microns to 10 microns), fines, and dust of adjacent purification media layers did not occur or did not negatively impact purifier performance.

During an investigation, a number of purification devices were opened and examined. It was found that several purification devices used wire mesh material between the bed layers. A physical mechanism for securing the wire mesh material to the housing in these devices was not observed.

An experiment was performed to determine the effect of purification media particle (includes microparticles and millimeter sized media particles) migration on gas purifier performance.

The test gas was hydrogen (AirGas Industrial Grade) at a flow rate of 5 standard liters per minute and pressure of 30 pounds per square inch. The detection system was APIMS (atmospheric pressure ionization mass spectroscopy). Purifier media included in one layer nickel metal on a high surface area support media and a desiccant media for the adjacent layer.

In this example, the membrane was a stainless steel cloth/felt that was cut to fit within the internal diameter of the purifier housing. This disk of membrane was placed on top of the first layer of the purification media in the housing for each of the test purifiers. The membrane had a nominal 0.1 micron pore size which, for the media used in this example, prevents the media from an adjacent bed from coating the downstream layer.

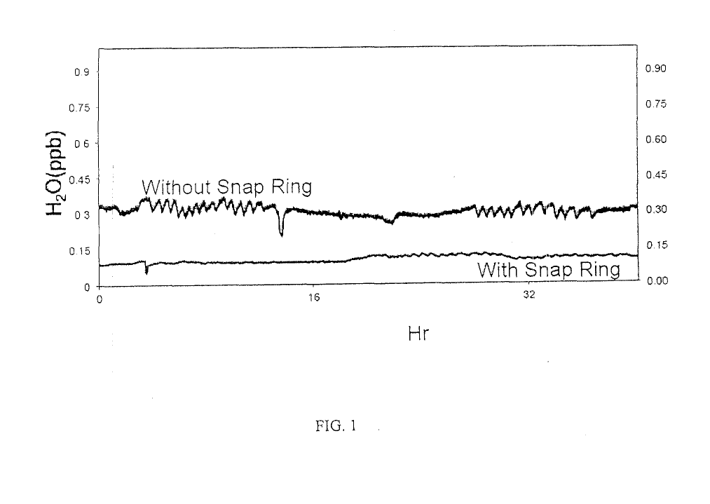

For one test purifier the upstream media was loaded directly onto the felt membrane—this purifier is designated as “Without Snap Ring” in FIG. 1. The housing was completed as illustrated in FIG. 3 using an upstream fit 301.

In the other test purifier, a retaining ring was used to secure the felt membrane firmly against the downstream media and housing. Upstream media was then loaded onto this assembly and the housing completed as illustrated in FIG. 3 using an upstream frit 301.

The moisture concentrations in the graph were from two test purifiers challenged with hydrogen gas under similar test conditions; each purifier had the same purifier media layers with the same felt membrane (nominal 0.1 micron pore size) between layers of purifier media. In one case the purifier was without a retaining ring to hold the membrane in place (top trace, FIG. 1), and in the other case, the test purifier used a retaining ring to hold the membrane in place (bottom trace, FIG. 1).

HX purifier evaluation was conducted in a 70 K sized Entegris purifier body. HX purifier is a two-layered packed bed, including one layer of Ni/NiO extrudate and a second layer of 13 X molecular sieves downstream having approximately 0.7 mm bead size (20×50 mesh) and stainless steel felt as the porous membrane. The top trace of FIG. 1 illustrates that for the same purifier media layers over the 32 hours of the test, the moisture concentration in hydrogen outlet from the purifier was lower (0.098 ppb _{v/v}) and had lower standard deviation (0.015 ppb _{v/v}) with the retaining ring to secure the edges of the membrane against the housing and downstream media when compared to the moisture concentration in hydrogen outlet from the purifier without the retaining ring which was (0.315 ppb _{v/v}) with a standard deviation (0.098 ppb _{v/v}). Prevention of extrudate migration with a retaining ring correlated with improved moisture removal performance of the gas filtration device.

Example 2. Implementing a retaining ring prevents migration of purification media between layers.

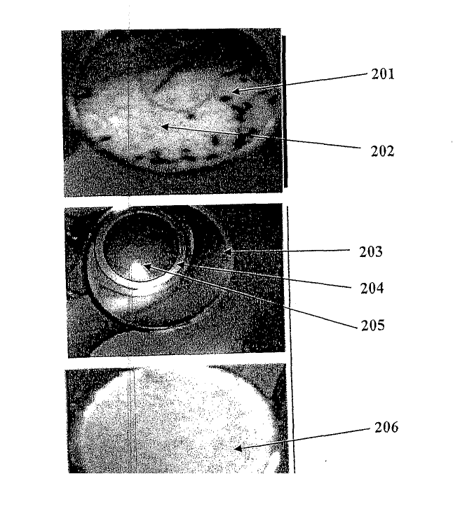

Migration of nickel extrudate during purifier assembly, activation, and usage can result in a loss in moisture impurity at the purifier outlet during its operation in H₂ gas. In the top image of FIG. 2, a membrane filter was placed between two separation media layers without a retaining ring. This solution was inadequate to prevent Ni migration, as shown. The top image of FIG. 2 shows downstream media just below felt screen membrane in a purifier that was used without retaining ring in place. There are small black particles 201 of the upstream media that are clearly visible around the edges of the sample and the downstream media 202 has a discolored appearance indicative of the darker fines of upstream media coating the downstream media. Without a retaining ring, the membrane is ineffective due to its ability to tilt during operation. A retaining ring 204 was inserted into the housing 203 on top of the membrane 205, as shown in the center. The implementation of the retaining ring proved to be effective in preventing media particle migration, as shown in the bottom image of FIG. 2, which shows the downstream media 206 just below felt screen in a purifier after use with a retaining ring in place. There were no small black particles of the upstream media or discoloration of the downstream media. The downstream media retained its white appearance and showed that by securing the felt screen membrane at its edges, upstream media migration was prevented.

This example shows that by securing a felt membrane between media layers, where an entire surface of the membrane is in firm contact with the downstream media and the membrane is in a fixed relationship with the housing, that the secured membrane was able to significantly or completely eliminate migration of the upstream media into the downstream media as shown in FIG. 2 and the purifier was able to reach much lower levels of purification and stability as shown in the FIG. 1.

Although the present invention has been described in considerable detail with reference to certain versions thereof, other versions are possible. Therefore the spirit and scope of the appended claims should not be limited to the description and the versions contain within this specification.

The teachings of all patents, published applications and references cited herein are incorporated by reference in their entirety.

What is claimed is:

1. A gas purifier, comprising:
a housing having a fluid inlet and a fluid outlet, the inlet and outlet fluidly connected through a purifier bed contained in the housing, the purifier bed comprising:
a first bed of purification media;
a second bed of purification media; and
a media-retaining porous membrane separating the first bed of purification media and the second bed of purification media, wherein the media-retaining membrane is secured within the housing at its edges by an expandable ring comprising an inner circumference, an outer circumference and a locking mechanism for expanding and retaining the ring by radial force against an inner wall of the housing when the locking mechanism is engaged.

2. The gas purifier of claim 1, wherein the media-retaining porous membrane is a gas-permeable membrane having a pore size to prevent particles of purification media from passing therethrough.

3. The gas purifier of claim 1 or claim 2, wherein the media-retaining porous membrane is in intimate and retaining contact with a first bed of purification media.

4. The gas purifier of any one of claims 1 to 3, wherein the media-retaining porous membrane is fixed between a surface of the expandable ring and a surface of a downstream bed of purification media.

5. The gas purifier of any one of claims 1 to 4, wherein the first bed of purification media and the second bed of purification media are compositionally the same or compositionally different.

6. The gas purifier of any one of claims 1 to 5, wherein the first bed of purification media and the second bed of purification media each independently comprise a metal catalyst on high surface area support media, dessicant material, molecular sieves, zeolites, an organometallic reagent on support media, getter material, or carbon-based media.

7. The gas purifier of any one of claims 1 to 6, wherein the media-retaining porous membrane comprises a material that is metallic, semi-metallic, carbon based, ceramic, polymeric, or thermally conductive.

8. The gas purifier of any one of claims 1 to 7, wherein the media-retaining porous membrane is a felt, a wire mesh, sintered particles, electro-blown fibers, woven membrane, or non-woven membrane.

9. The gas purifier of any one of claims 1 to 8, wherein the locking mechanism is spring-locking mechanism.

10. The gas purifier of any one of claims 1 to 9, wherein the expandable ring is secured by radial force between the outer diameter of the expandable ring and the inner wall of the housing.

11. The gas purifier of any one of claims 1 to 10, wherein the expandable ring comprises metal (e.g., stainless steel), plastic, or metal alloy.

12. The gas purifier of any one of claims 1 to 11, wherein the expandable ring has a thickness of from about 0.06 inches to about 0.12 inches.

13. The gas purifier of any one of claims 1 to 12, wherein the media-retaining porous membrane has a pore size of from about 0.05 microns to about 1.0 microns.

14. The gas purifier of any one of claims 1 to 13, wherein, in use, the gas purifier is oriented vertically or horizontally.

15. The gas purifier of any one of claims 1 to 14, further comprising one or more additional beds of purification media and optionally one or more additional media-retaining porous membranes, wherein the additional membrane, if present, separates any two beds of purification media.

16. A gas purifier comprising an upstream purification media and a downstream purification media in a housing, the upstream and downstream purification media capable of removing different impurities or amounts of impurities from a gas stream;
a) the upstream and downstream purification media are separated by a porous felt membrane that is in an intimate and retaining contact relationship with the downstream media layer, the contact of the porous felt membrane with the downstream media holds the downstream media in place in the housing, said contact allows the purifier to be used in any orientation without channeling occurring in downstream media during use of the purifier,
b) the edges of the porous felt membrane that are in contact with the downstream media are secured with a ring against the downstream media to give a fixed porous felt membrane in the housing, said porous fixed felt membrane directs gas flow and any upstream media particles or microparticles therein to flow through the porous felt membrane where upstream media particles and upstream media microparticles are retained.

17. An expandable media-retaining ring, comprising:
an expandable ring comprising an inner circumference, an outer circumference and a locking mechanism for expanding and retaining the ring when inserted into a filtration housing between media beds by radial force, wherein the retaining feature is activated when the locking mechanism is engaged; and
a media-retaining porous membrane comprising a gas-permeable material of pore size to prevent media from passing therethrough; wherein the media-retaining porous membrane is optionally affixed to the expandable ring.

18. The expandable media-retaining ring of claim 17, wherein the expandable ring comprises metal (e.g., stainless steel), plastic, or metal alloy.

19. The expandable media-retaining ring of claim 17 or claim 18, wherein the expandable ring has a thickness of from about 0.06 inches to about 0.12 inches.

20. The expandable media-retaining ring of any one of claims 17 to 19, wherein the locking mechanism is a spring-locking mechanism.

21. The expandable media-retaining ring of any one of claims 17 to 20, wherein the gas-permeable material is metallic, semi-metallic, carbon based, ceramic, polymeric, or thermally conductive.

22. The expandable media-retaining ring of any one of claims 17 to 21, wherein the media-retaining porous membrane is a felt, a wire mesh, sintered particles, electro-blown fibers, woven membrane, or non-woven membrane.

23. The expandable media-retaining ring of any one of claims 17 to 22, wherein the media-retaining porous membrane has a pore size of from about 0.05 microns to about 1.0 microns.
